(19) United States
(12) Patent Application Publication
(10) Pub. No.: US 2006/0136788 A1
(43) Pub. Date: Jun. 22, 2006

(54) Test system and method

(76) Inventors: Chih-Jen Hsu, Miao Li Hsien (TW); Dar-Lun Chen, Si Jhih City (TW)

Correspondence Address: RABIN & Berdo, PC, 1101 14TH STREET, NW, SUITE 500, WASHINGTON, DC, 20005, US

(21) Appl. No.: 11/283,842

(22) Filed: Nov. 22, 2005

(30) Foreign Application Priority Data
Dec. 7, 2004 (TW) 93137855

(51) Int. Cl. G06F 11/00

(52) U.S. Cl. 714/42

(57) ABSTRACT

A test system including a generating unit, a knowledge base, a collecting unit and a determining unit is provided. The generating unit is for generating a test case according to a test plan. The knowledge base is for providing a test item and a corresponding checking method according the test plan. The collecting unit is for collecting the system information from a device under test. The determining unit is for checking whether the system information has the test item according the checking method. And whether the test item passes or fails is determined by the determining unit according. the checking result.

This application claims the benefit of Taiwan application Serial No. 93137855, filed Dec. 7, 2004, the subject matter of which is incorporated herein by reference.

### BACKGROUND OF THE INVENTION

1. Field of the Invention

The invention relates in general to a test system and method, and more particularly to a test system and method of standardizing and formatting the test case to be stored in the knowledge base.

2. Description of the Related Art

With the rapid advancement in science and technology, computer has become in indispensable tool to modern people. Especially the notebook computer, with the features of lightweight, slimness, compactness and portability, provides high convenience and availability whenever and wherever as needed, further enhancing efficiency in terms of work and everydayness.

Before a notebook computer leaves the factory, the inspector would test the software/hardware components of the notebook computer according to the client's test plan. For example, if the client expects the maker and the version of the video adapter driver of the notebook computer to be X and Y respectively, then the inspector has to inspect whether the maker and the version of the video adapter driver respectively are X and Y or not. The quality inspection and assurance in terms of the software and hardware of the computer system requires a large number of inspectors to simulate the operation of an end user with an aim to check and find out the defective software/hardware components of a computer system. For example, some defects generated during the conventional inspection, such as any software/hardware components are left out, incompletely installed, errors in operation, or operated inappropriately, would affect the test results.

Under the human inspection, the inspector, according to test case generated by the specification of the computer system, inspects the software/hardware components item by item and the possible test items generated under different environment of every software/hardware component. For example, the test items generated under different operating system and versions would be different. Examples of the test items corresponding to the test case include installation of software/hardware components being left out, installation of software/hardware component being incomplete, errors of software/hardware component occurring during operation, and versions of software/hardware components being incorrect. Besides, the inspector has to check whether the marker and the version of the video adapter driver are requested by the client from the system information of a device under test. If yes, the inspector determines that the test item is passed, otherwise, the inspector determines that the test item is failed.

However, there are problems arising when human inspection is employed in inspecting the test cases. For example, the inspector might be lack of the knowledge of component function and installation and the system language of computer, the inspector might have negligence in inspection, the inspector might have erroneous judgment on component performance, or the component might have different performance under different system environments. Besides, the time-consuming process of human inspection is an imminent shortcoming to be resolved.

### SUMMARY OF THE INVENTION

It is therefore the object of the invention to provide a test system and method. The test case and target system information are formatted, and the checking method recorded in the knowledge base is used to test the corresponding test item of the test case. Besides, a high efficiency and high quality test procedure is achieved by updating, maintaining and re-using the checking method stored in the knowledge base.

According to an object of the invention, a test system including a generating unit, a knowledge base, a collecting unit and a determining unit is provided. The generating unit is for generating a test case according to a test plan. The knowledge base is for providing a test item and a corresponding checking method according the test plan. The collecting unit is for collecting the system information from a device under test. The determining unit is for checking whether the system information has the test item or not according the checking method. Then, the determining unit determines whether the test item is passed or failed according the checking result.

The determining unit determines that the test item is passed when the determining unit checks that the system information has the test item according to the checking method.

The determining unit determines that the test item is failed when the determining unit checks that the system information doesn't have the test item according to the checking method.

According to another object of the invention, a checking method is provided. The method includes the steps of generating a test case according to a test plan, providing a test item and a corresponding checking method according to the test case, collecting the system information from a device under test, and checking whether the system information has the test item or not according to checking method.

The test item is determined to be passed when the system information has a test item.

The test item is determined to be failed when the system information doesn't have the test item.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a test system according to a first embodiment of the invention; and

FIG. 2 is a flowchart of a test method according to a second embodiment of the invention.

### DETAILED DESCRIPTION OF THE INVENTION

### First Embodiment

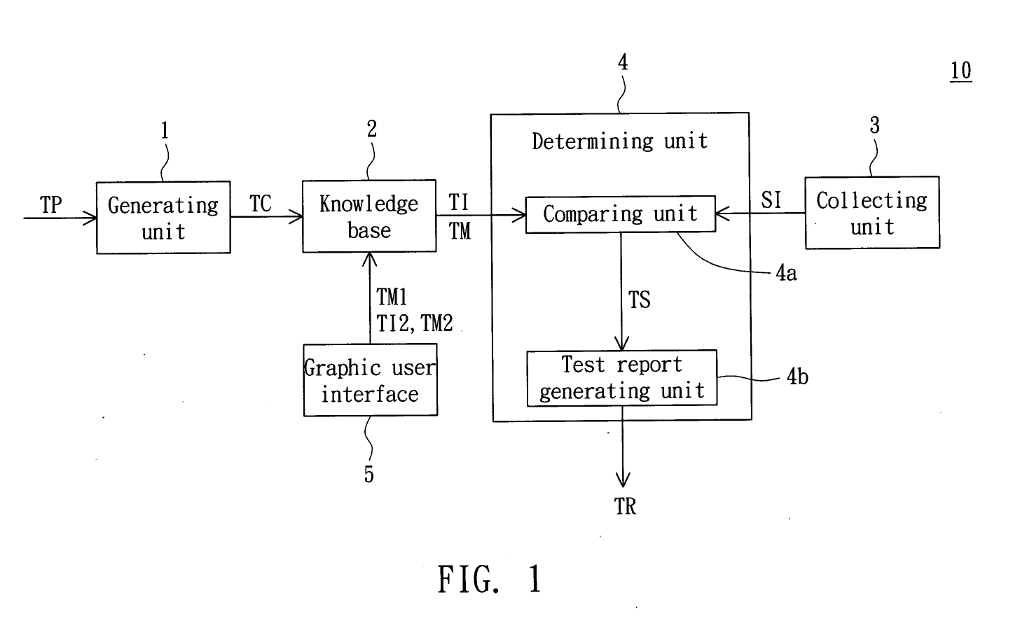

Referring to FIG. 1, a block diagram of a test system according to a first embodiment of the invention is shown. In FIG. 1, the test system 10 includes a generating unit 1, a knowledge base 2, a collecting unit 3, a determining unit 4 and a graphic user interface (GUI) 5. The generating unit 1 is for generating at least a test case TC complying with the need of the test system 10 according to a test plan TP provided by a client. The test plan can be an oral statement, a text file, a facsimile or an e-mail provided by the client. The test plan recites that whether the manufactured devices under test are complied with the requests of the client or not. For example, if it is stated in the test case TC that the client request the maker and version of video adapter driver of the notebook computer to be X and Y, then the test system 10 would determine whether the maker and version of video adapter driver of the manufactured notebook computer under test are respectively X and Y according to the test case TC. If yes, the manufactured notebook computer complies with the client's requests, otherwise the manufactured notebook computer does not comply with client's requests. However, since each client's test plan is different in terms of standard and format, the inspector can use the generating unit 1 to input or convert each client's test plan to a test case applicable to the test system 10, so that the test case can be standardized and formatted.

The knowledge base 2, a database based on the inspector's experience of inspection with regards to test items and checking methods, is electrically connected to the generating unit 1 for providing at least a test item TI and a corresponding checking method TM according to the test case TC. The knowledge base 2 is capable of storing a large amount of test items and checking methods corresponding to the test case TC. For example, the test item of “The Maker of Video Adapter Driver Being X”, the checking method of “How to Find the Maker of Video Adapter Driver From the System Information of a Device Under Test”, the test item of “The Version of Video Adapter Driver Being Y” and the checking method of “How to Find the Version of Video Adapter Driver From the System Information of a Device Under Test”.

The collecting unit 3 is for collecting the system information SI from a device under test. The system information SI would list the raw data of all software and hardware of the device under test such as the maker and the version of video adapter driver of the device. The determining unit 4 is electrically connected to the knowledge base 2 and the collecting unit 3, respectively. The determining unit 4 is for checking whether the system information SI has a test item TI or not according to checking method TM, and then determining the test item TI is passed or failed according the checking result. At first, the determining unit 4 checks whether the system information SI has a raw data stating that the maker of video adapter driver is X or not according to the checking method of “How to Find the Maker of Video Adapter Driver From the System Information of a Device Under Test”. Next, the determining unit 4 checks whether the system information SI has a raw data stating that the version of video adapter driver is Y or not according to the checking method of “How to Find the Version of Video Adapter Driver From the System Information of a Device Under Test”.

When the determining unit 4 checks that the system information SI has the test item TI according to the checking method TM, the determining unit 4 determines that the test item TI is passed. When the determining unit 4 checks that the system information SI doesn't have the test item TI according to the checking method TM, the determining unit 4 determines that the test item TI is failed. When the determining unit 4 determines that the test item TI is passed or failed, the determining unit 4 further generates a test report TR showing that the test item TI is passed or failed. Thus, the client can learn from the test report TR and determines whether the device under test, which is exemplified by a notebook computer in the embodiment, complies with the requirements or not.

The comparison process of the determining unit 4 is stated below. At first, the determining unit 4 checks whether the system information SI has a raw data stating that the maker of video adapter driver is X or not according to the checking method of “How to Find the Maker of Video Adapter Driver From the System Information of a Device Under Test”. If the determining unit 4 checks that the system information SI has the raw data stating that the maker of video adapter driver is X, the determining unit 4 determines that the test item of “The Maker of Video Adapter Driver Being X” is passed. If the determining unit 4 checks that the system information SI doesn't have the raw data stating that the maker of video adapter driver is X, the determining unit 4 determines that the test item of “The Maker of Video Adapter Driver Being X” is failed.

Next, the determining unit 4 checks whether the system information SI has a raw data stating that the version of video adapter driver is Y or not according to the checking method of “How to Find the Version of Video Adapter Driver From the System Information of a Device Under Test”. If yes, the determining unit 4 determines that the test item of “The Version of Video Adapter Driver Being Y” is passed, otherwise the determining unit 4 determines that the test item of “The Version of Video Adapter Driver Being Y” is failed. Then, after the determining unit 4 has determined that each of the all test items is passed or failed, the determining unit 4 further generates a test report showing that each of the all test items is passed or failed according to the checking result. The test report TR contains the data with regard to that the test items of “The Maker of Video Adapter Driver Being X” and “The Version of Video Adapter Driver Being Y” are respectively passed or failed for the client's reference.

In the present embodiment the determining unit 4 further includes a comparing unit 4a and a test report generating unit 4b. The comparing unit 4a is electrically connected to the knowledge base 2 and the collecting unit 3, respectively. The comparing unit 4a is for checking whether the system information SI has a test item TI or not according to the checking method TM, then determining whether the test item TI is passed or failed according the checking result and outputting a test result TS stating that the test item TI is passed or failed. The test report generating unit 4b electrically connected to the comparing unit 4a is for generating a test report TR showing that the test item TI is passed or failed according to the test result TS when the comparing unit 4a determines that the test item TI is passed or failed.

The determining unit 4 further has a test item analyzing function and a knowledge base controlling function. On one hand, according to the test item analyzing function, the determining unit 4 is capable of converting the test item TI to the data more applicable to be compared against the system information SI of the device under test, so that the determining unit 4 can easily determine whether the test item TI is passed or failed. On the other hand, according to the knowledge base controlling function, the determining unit 4 is capable of retrieving the checking method TM corresponding to the test item TI from the knowledge base 2.

Besides, when the determining unit 4 determines that the test item TI is failed, the determining result may be true or the situation that the determining unit 4 doesn't know how to check whether the system information SI has the test item TI or not. Meanwhile, if the determining unit 4 doesn't know how to check whether the system information SI has the test item TI or not, the inspector can understand the situation according the test result TS or the test report TP. For the determining unit 4 to check whether the system information SI has the test item TI according to an appropriate checking method, the inspector can input a new checking method TM1 corresponding to the test item TI through the GUI 5, and the checking method TM1 is stored in the knowledge base 2. Or, in order to increase a new test item and a new checking method corresponding to a new test case, the inspector can input a new test item T12 and a corresponding checking method TM2 through the GUI 5, and the test item T12 and the checking method TM2 are stored in the knowledge base 2. Thus, the test item and checking method corresponding to the test case stored in the knowledge base 2 can be updated. The GUI 5 is electrically connected to the knowledge base 2.

Through the establishment of the knowledge base of the present embodiment, different test items and checking methods are provided in correspondence to different test cases, so that the problems arising when conventional human inspection is employed can be avoided and the time-consuming process of human inspection can be resolved by the automation of inspection as well. Examples of the problems arising in human inspection include that the inspector might be lack of the knowledge of component function and installation and the system language of computer, that the inspector might have negligence in inspection, that the inspector might have erroneous judgment on component performance, or that the component might have different performance under different system environments. In the present embodiment of the invention, the test case and target system information are formatted, and the checking method recorded in the knowledge base is used to test the corresponding test item of the test case. Besides, a high efficiency and high quality test procedure is achieved by updating, maintaining and re-using the checking method stored in the knowledge base.

### Second Embodiment

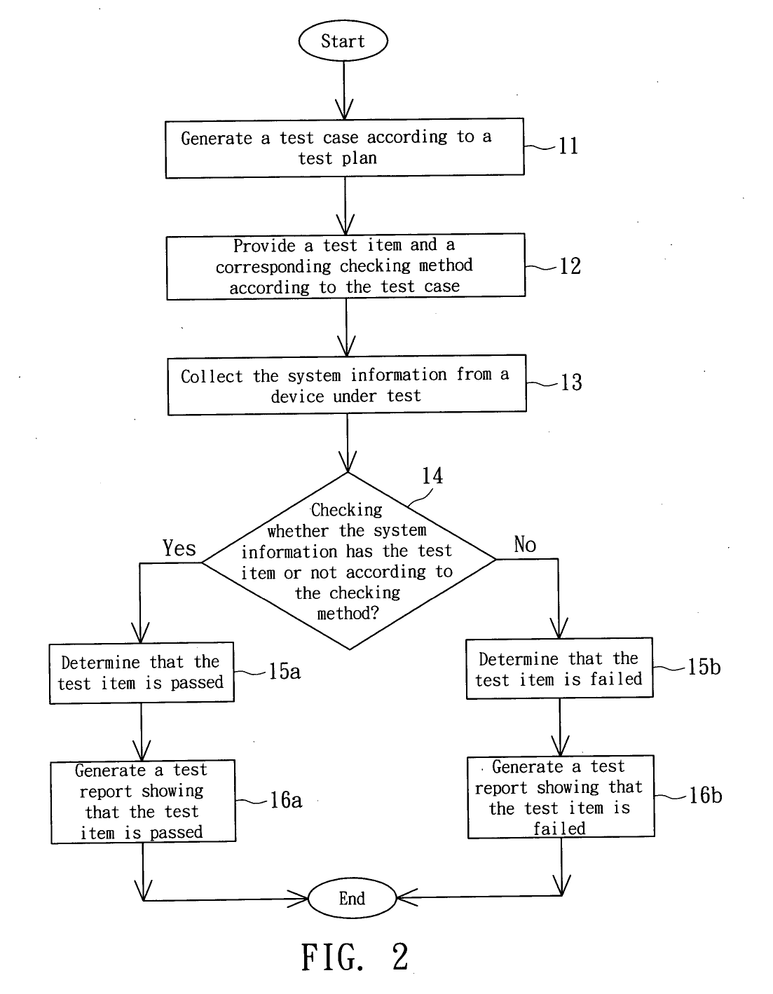

Referring to FIG. 2, a flowchart of a test method according to a second embodiment of the invention is shown. In FIG. 2, at first, the method begins at step 11, a test case TC applicable to the test system 10 is generated by the generating unit 1 according to a test plan TP provided by the client. Next, proceed to step 12, a test item TI and a corresponding checking method TM are provided by the knowledge base 2 according to the test case TC. Then, proceed to step 13, the system information SI is collected from a device under test by the collecting unit 3. Next, proceed to step 14, whether the system information SI has the test item TI or not is checked by the determining unit 4 according to the checking method TM.

When the system information SI is checked to have the test item TI, proceed to step 15a, the test item TI is determined to be passed. Next, proceed to step 16a, a test report TR showing that the test item TI is passed is generated.

When the system information SI is checked to have not the test item TI, proceed to step 15b, the test item TI is determined to be failed. Next, proceed to step 16b, a test report TR showing that the test item TI is failed is generated.

In the present embodiment, when the test item TI is determined to be failed, a checking method TM1 corresponding to the test item TI can be inputted through a GUI 5, and the checking method TM1 is stored in the knowledge base 2. Or, a test item TI 2 and a corresponding checking method TM2 can be inputted through a GUI 5 whenever required, and the test item TI 2 and the checking method TM2 are stored in knowledge base 2. Besides, the client can realize whether the device under test complies with the requests or not according to test report TR.

According to the test system and method disclosed in above embodiments of the invention, the test case is standardized and formatted, and then stored in the knowledge base. Further more, the test cases stored in the knowledge base are updated and amended along with the tests. The knowledge base is generated according to the standardized test cases. By testing the components of the device according to a software automation method, the test efficiency is effectively increased, the erroneous judgment made by the inspector is largely reduced, and the inspector's experience and knowledge of testing the components are accumulated. And a test procedure of high efficiency and high quality is thus achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A test system, comprising:
a generating unit for generating a test case according to a test plan;
a knowledge base electrically connected to the generating unit for providing a test item and a corresponding checking method according to the test case;
a collecting unit for collecting the system information from a device under test; and
a determining unit electrically connected to the knowledge base and the collecting unit for checking whether the system information has the test item or not according to the checking method and then determining whether the test item is passed or failed according to the checking result.

2. The test system according to claim 1, wherein the determining unit determines that the test item is passed when the determining unit checks that the system information has the test item according to the checking method;
wherein the determining unit determines that the test item is failed when the determining unit checks that the system information doesn't have the test item according to the checking method.

3. The test system according to claim 2, wherein the determining unit further generates a test report showing that the test item is passed when the determining unit determines that the test item is passed.

4. The test system according to claim 2, wherein the determining unit further generates a test report showing that the test item is failed when the determining unit determines that the test item is failed.

5. The test system according to claim 2, further comprising:
a graphic user interface (GUI) electrically connected to the knowledge base for an inspector to input a first checking method corresponding to the test item when the determining unit determines that the test item is failed, wherein the knowledge base stores the first checking method.

6. The test system according to claim 2, further comprising:
a GUI electrically connected to the knowledge base for an inspector to input a first test item and a corresponding first checking method, wherein the knowledge base stores the first test item and the first checking method.

7. The test system according to claim 1, wherein the determining unit further comprising:
a comparing unit for checking whether the system information has the test item or not according to the checking method, and then determining whether the test item is passed or failed according to the checking result; and
a test report generating unit electrically connected to the comparing unit for generating a test report showing that the test item is passed or failed when the comparing unit determines whether the test item is passed or failed according to the checking result.

8. The test system according to claim 7, wherein the comparing unit determines that the test item is passed when the comparing unit checks that the system information has the test item according to the checking method;
wherein the comparing unit determines that the test item is failed when the comparing unit checks that the system information doesn't have the test item according to the checking method.

9. The test system according to claim 8, further comprising:
a GUI electrically connected to the knowledge base for an inspector to input a first checking method corresponding to the test item when the comparing unit determines that the test item is passed, wherein the knowledge base stores the first checking method.

10. The test system according to claim 8, further comprising:
a GUI electrically connected to the knowledge base for an inspector to input a first test item and a corresponding first checking method, wherein the knowledge base stores the first test item and the first checking method.

11. A test method, comprising:
generating a test case according to a test plan;
providing a test item and a corresponding checking method according to the test case;
collecting the system information from a device under test; and
checking whether the system information has the test item or not according to the checking method.

12. The test method according to claim 11, further comprising:
determining that the test item is passed when the system information has the test item; and
determining that the test item is failed when the system information doesn't have the test item.

13. The test method according to claim 12, further comprising:
generating a test report showing that the test item is passed when the test item is determined to be passed.

14. The test method according to claim 13, further comprising:
generating a test report showing that the test item is failed when the test item is determined to be failed.

15. The test method according to claim 14, further comprising:
inputting a first checking method corresponding to the test item when the test item is determined to be failed; and
storing the first checking method.

16. The test method according to claim 14, further comprising:
inputting a first test item and a corresponding first checking method; and
storing the first test item and the first checking method
